(19) United States
(12) Patent Application Publication
(10) Pub. No.: US 2025/0236462 A1
(43) Pub. Date: Jul. 24, 2025

(54) RACK-MOUNTED AUTOMATED PICKING SYSTEM

(71) Applicants: Russ Hempstead, Lafayette, CO (US); Keir Hart, Lafayette, CO (US)

(72) Inventors: Russ Hempstead, Lafayette, CO (US); Keir Hart, Lafayette, CO (US)

(21) Appl. No.: 19/023,658

(22) Filed: Jan. 16, 2025

Related U.S. Application Data
(63) Continuation-in-part of application No. 63/622,478, filed on Jan. 18, 2024.

(51) Int. Cl. B65G 1/137

(52) U.S. Cl. CPC B65G 1/1373

(57) ABSTRACT

Disclosed is a robotic picker comprising a U-shaped frame having a pair of retractable arms slidingly engaged on an inside portion of two sides of the U-shaped frame, wherein the pair of retractable arms are connected to arm extension motors. The arm extension motors are configured to extend and retract the pair of retractable arms from the two terminal ends of the U-shaped frame. Each of the retractable arms comprise a motorized gripping bar that confront one another, wherein the motorized gripping bars are configured to be driven towards or away from one another via gripping bar motors to grip a package. The U-shaped frame cooperates with a vertical frame via a vertical drive motor that is configured to move the U-shaped frame vertically along the vertical frame. A horizontal displacing platform carries the vertical frame horizontally along a shelf.

### CROSS-REFERENCE TO RELATED APPLICATIONS

This application claims priority to and the benefit of U.S. Provisional Patent Application No. 63/622,478 entitled: RACK-MOUNTED AUTOMATED PICKING SYSTEM, filed on Jan. 18, 2024.

### FIELD OF THE INVENTION

The present invention relates to automated picking and placing of containers on shelves in a warehouse or similar environment.

### BACKGROUND

Warehouse personnel are typically responsible for picking and distributing parts, boxes, drums, and pallets off racking or shelving units where these items are stored. The process of obtaining these containers from the racking presents several safety hazards for the items stored, equipment used in the warehouse, and any persons working in that warehouse, including risk of falls and physical stress from lifting that may result in injuries.

It is to improvements in automated picking and placing of containers on shelves in a warehouse that embodiments of the present invention are generally directed.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

The present invention is generally directed to automated picking and placing of containers on shelves in a warehouse or similar environment.

Certain embodiments of the present invention can therefore comprise an automatic system for picking and placing containers on a rack or shelving unit, or onto a manual or automated cart. One embodiment of this system envisions a hub being configured to communicate with one or more robots, at least one automated cart, and the warehouse management software. In this embodiment, software on the automated system converts the list of materials requested by the warehouse management software into rack or shelving unit locations for the robots to pick from and provides drop off or parking locations for an automated cart. A modular robot that comprises an extension platform and at least one drive unit rides on a series of horizontal and driven vertical supports coupled to the warehouse rack or shelving unit. A grasping mechanism that comprises an extension mechanism and capture mechanism extends and retracts from an extension platform to pick and place containers. Sensors and safety mechanisms throughout the automated system stop system motion as well as indicate system state. Automated carts bring picked materials to a predetermined drop off or return materials for the robot to place on the rack or shelving unit.

Various other features, objects, and advantages will be made apparent from the following description taken together with the drawings.

### BRIEF DESCRIPTION OF THE DRAWINGS

FIG. 1 is a block diagram of a system architecture consistent with embodiments of the present invention;

FIG. 2 is a flowchart of an embodiment of a hub and associated components and interfaces;

FIG. 3 is a flowchart of an embodiment of a robot controller and associated components and interfaces;

FIG. 4 is a top-down plan view of an example of a rack-mounted automated picking system consistent with embodiments of the present invention;

FIG. 5 is a side view of an example rack-mounted automated picking system consistent with embodiments of the present invention;

FIG. 6 is a perspective view of an example rack-mounted automated picking system consistent with embodiments of the present invention;

FIG. 7 is a perspective view of an example rack-mounted automated picking system depicting the U-shaped robot an respective attachments consistent with embodiments of the present invention;

FIG. 8 depicts a rack-mounted automated picking system in the default/waiting state consistent with embodiments of the present invention;

FIG. 9 depicts the rack-mounted automated picking system locating a container consistent with embodiments of the present invention;

FIG. 10 depicts the extended base sensor locations consistent with embodiments of the present invention;

FIG. 11 depicts the rack-mounted automated picking system in the extended state consistent with embodiments of the present invention;

FIG. 12 depicts a closeup of the base in an extended state consistent with embodiments of the present invention;

FIG. 13 depicts the rack-mounted automated picking system in the container picked state consistent with embodiments of the present invention;

FIG. 14 depicts a closeup view of the extended base in the container picked state consistent with embodiments of the present invention;

FIG. 15 depicts the rack-mounted automated picking system in the container drop off state consistent with embodiments of the present invention;

FIG. 16 depicts an exploded view of the automated system consistent with embodiments of the present invention;

FIG. 17 depicts the U-shaped picking device with a telescoping slide consistent with embodiments of the present invention;

FIG. 18 depicts the U-shaped picking device with a rack and pinion consistent with embodiments of the present invention; and

FIG. 19 illustratively depicts a ball screw arrangement consistent with embodiments of the present invention.

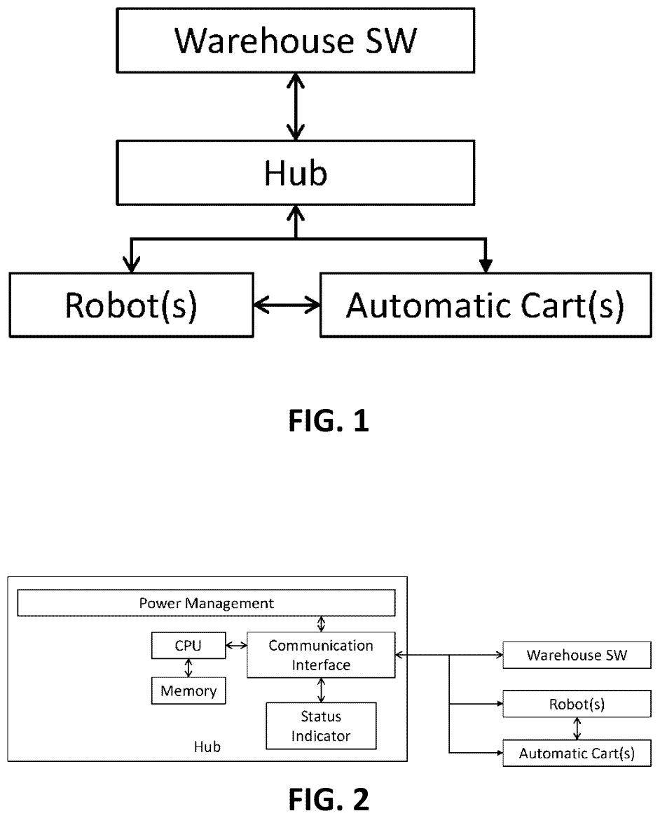

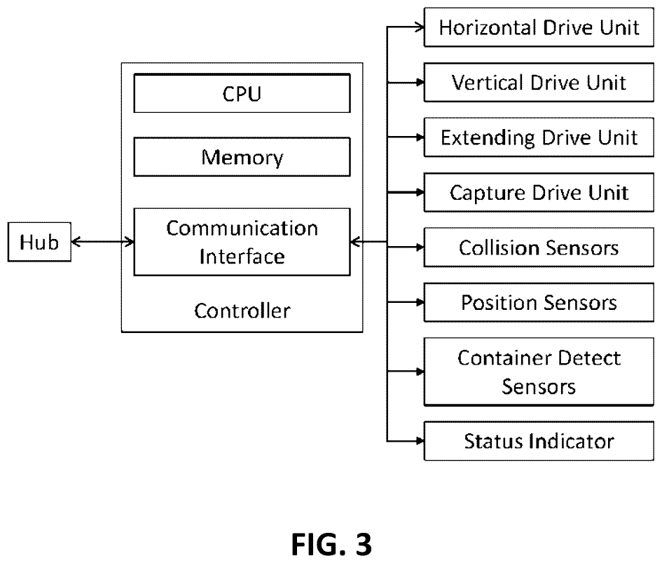

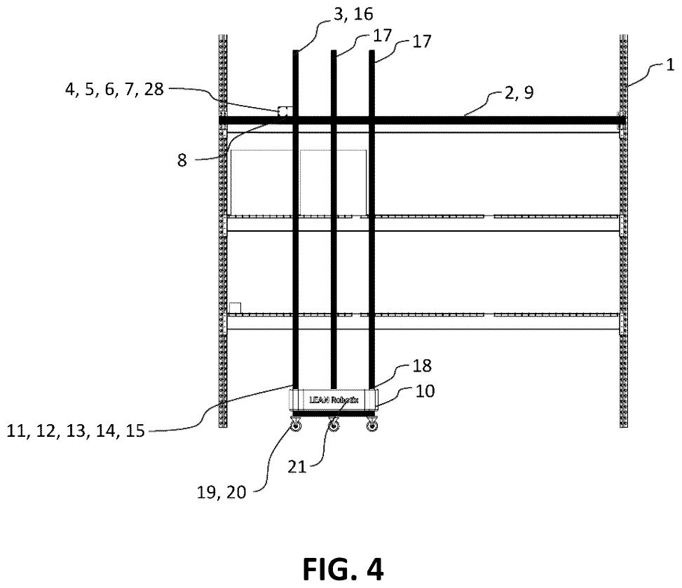

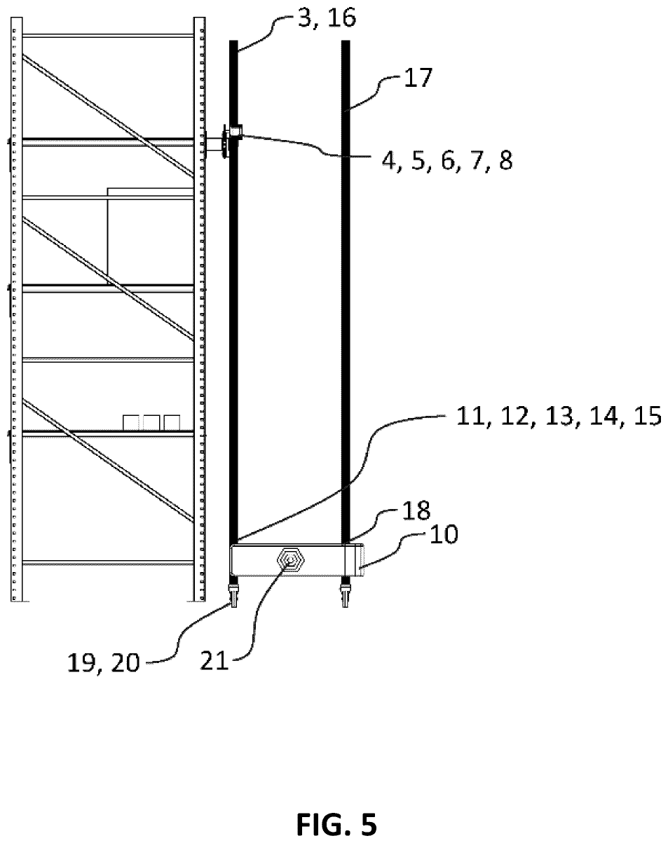

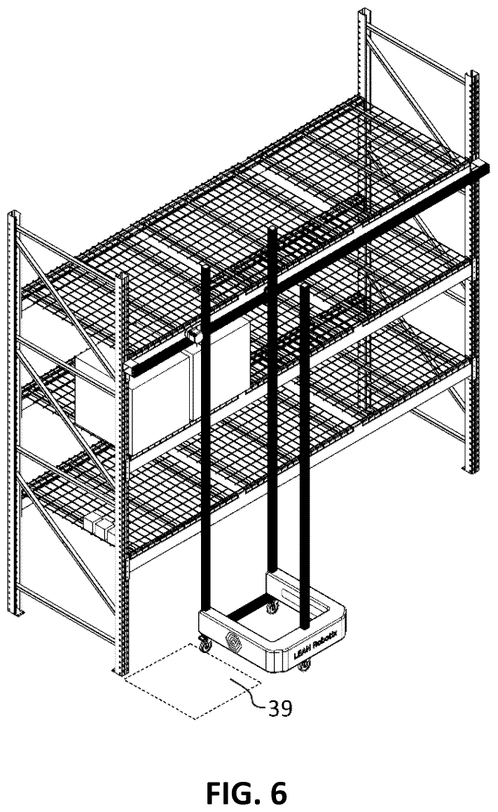

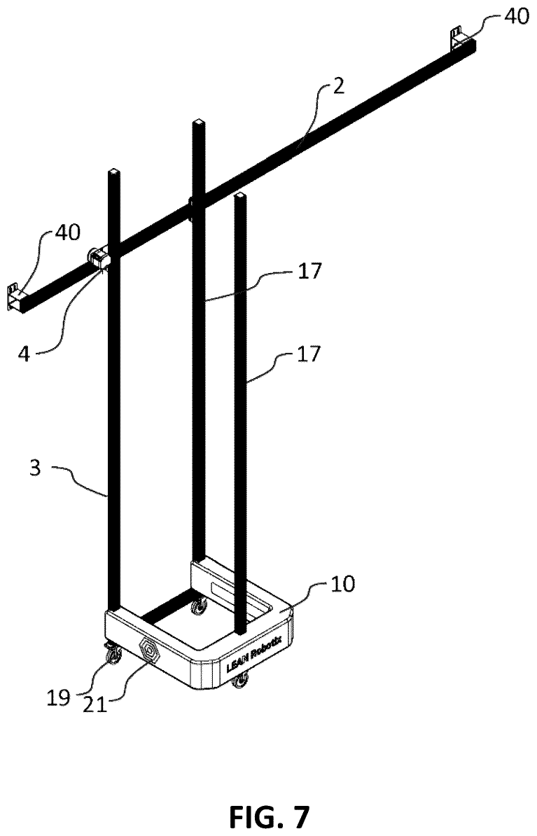

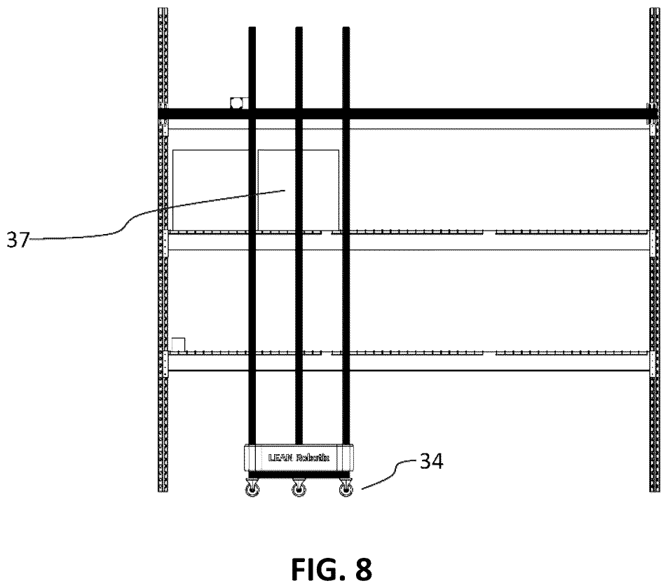

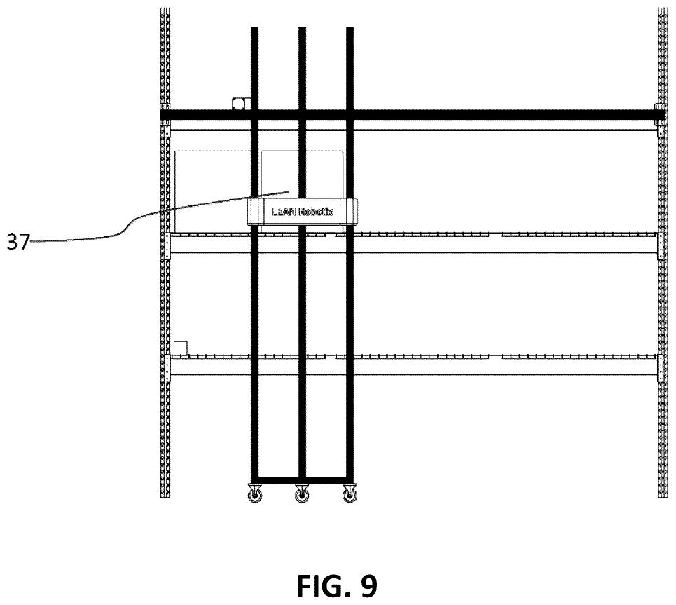

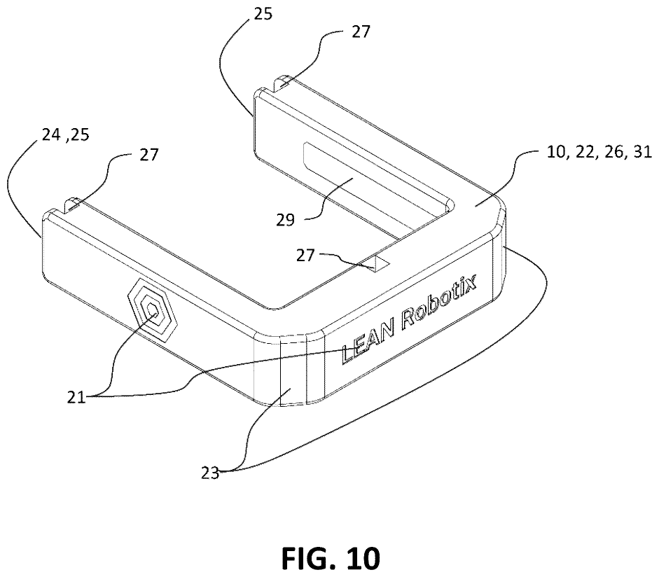

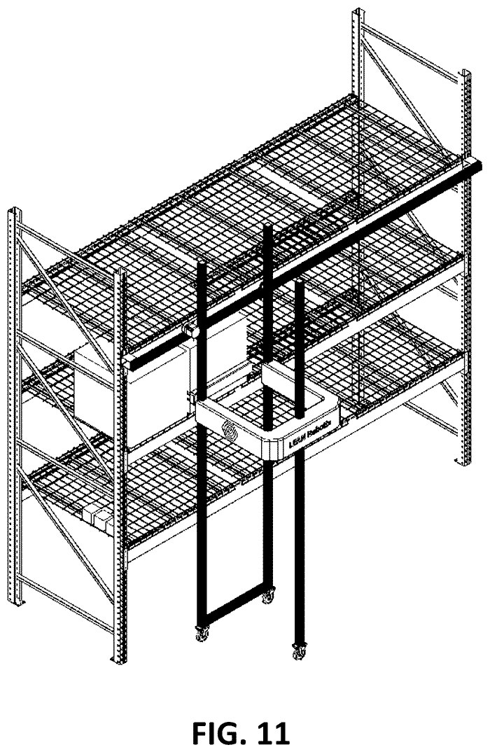

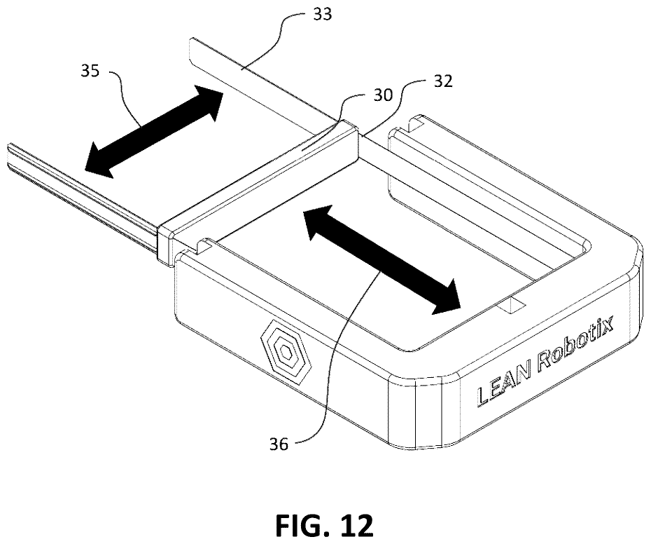

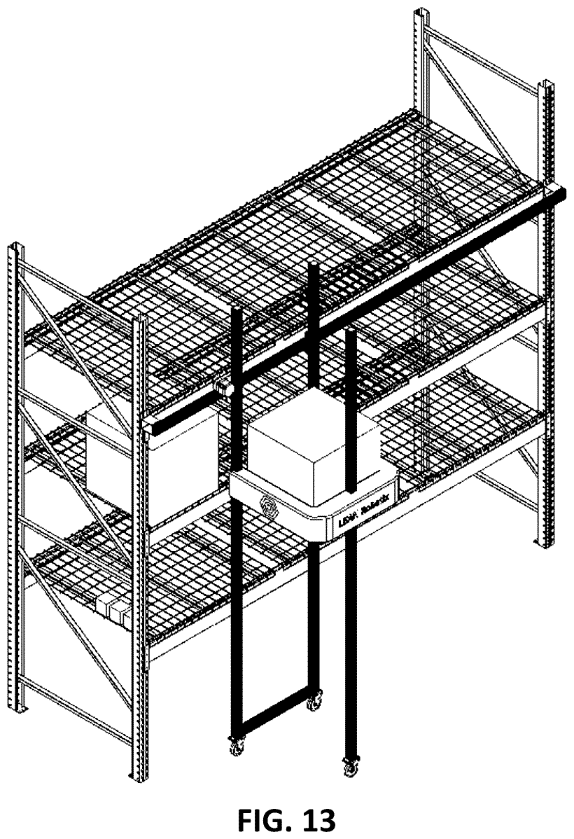

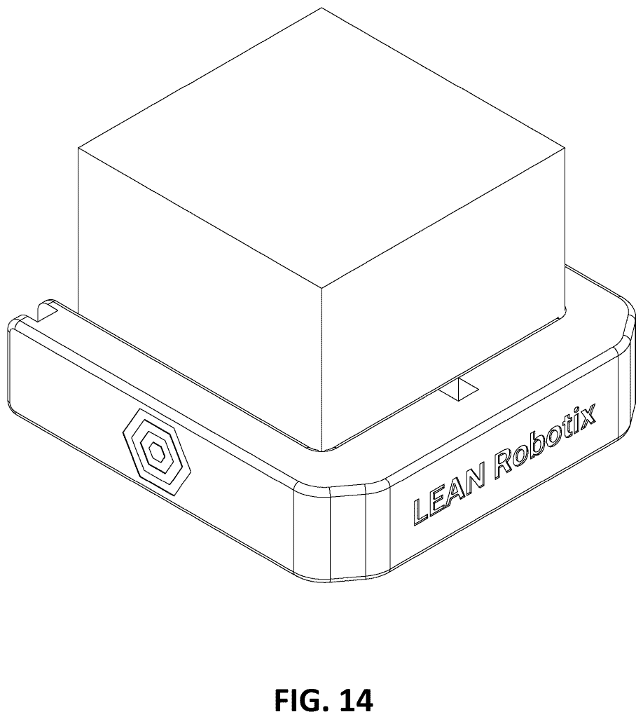

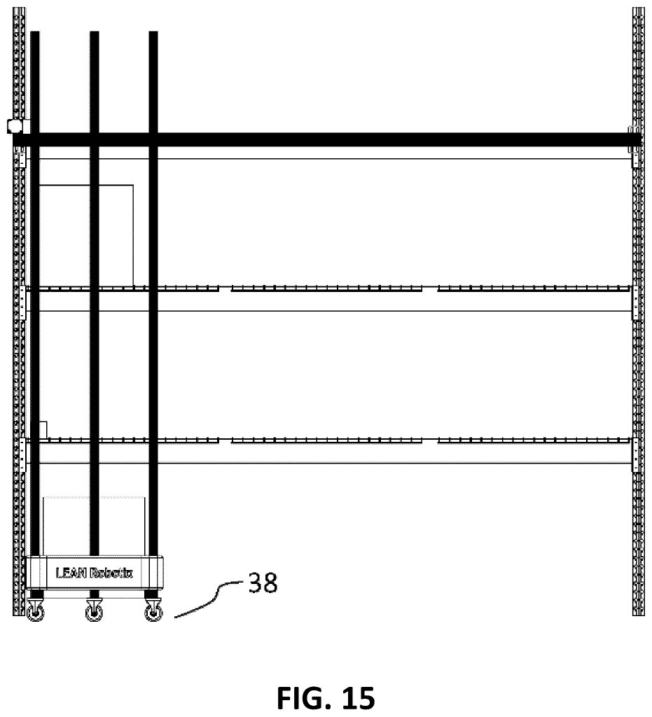

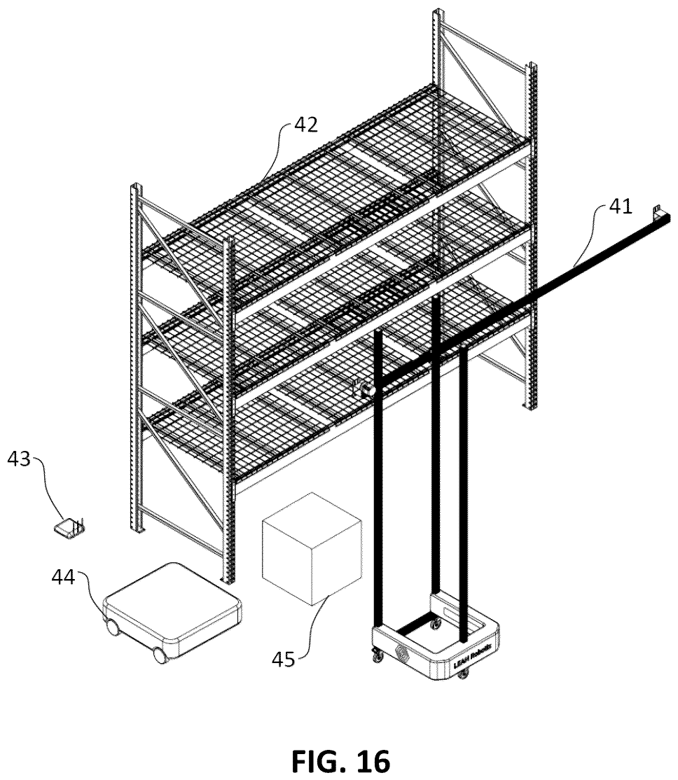

### DETAILED DESCRIPTION

Initially, this disclosure is by way of example only, not by limitation. Thus, although the instrumentalities described herein are for the convenience of explanation, shown and described with respect to exemplary embodiments, it will be appreciated that the principles herein may be applied equally in other similar configurations involving the subject matter directed to the field of the invention. The phrases “in one embodiment”, “according to one embodiment”, and the like, generally mean the particular feature, structure, or characteristic following the phrase, is included in at least one embodiment of the present invention and may be included in more than one embodiment of the present invention. Importantly, such phases do not necessarily refer to the same embodiment. If the specification states a component or feature “may”, “can”, “could”, or “might” be included or have a characteristic, that particular component or feature is not required to be included or have the characteristic. As used herein, the terms “having”, “have”, “including” and “include” are considered open language and are synonymous with the term “comprising”. Furthermore, as used herein, the term “essentially” is meant to stress that a characteristic of something is to be interpreted within acceptable tolerance margins known to those skilled in the art in keeping with typical normal world tolerance, which is analogous with “more or less.” For example, essentially flat, essentially straight, essentially on time, etc. all indicate that these characteristics are not capable of being perfect within the sense of their limits. Accordingly, if there is no specific +/− value assigned to “essentially”, then assume essentially means to be within +/−2.5% of exact. The term “connected to” as used herein is to be interpreted as a first element physically linked or attached to a second element and not as a “means for attaching” as in a “means plus function”. In fact, unless a term expressly uses “means for” followed by the gerund form of a verb, that term shall not be interpreted under 35 U.S.C. § 112(f). In what follows, similar or identical structures may be identified using identical callouts.

With respect to the drawings, it is noted that the figures are not necessarily drawn to scale and are diagrammatic in nature to illustrate features of interest. Descriptive terminology such as, for example, upper/lower, top/bottom, horizontal/vertical, left/right and the like, may be adopted with respect to the various views or conventions provided in the figures as generally understood by an onlooker for purposes of enhancing the reader's understanding and is in no way intended to be limiting. All embodiments described herein are submitted to be operational irrespective of any overall physical orientation unless specifically described otherwise, such as elements that rely on gravity to operate, for example.

Picking boxes, pallets, and other containers from a warehouse storage unit, such as a rack or shelving unit can be an unsafe activity due to the risk of slip-and-fall injuries and/or blunt-force injuries that commonly occur with a container falling onto a person or a warehouse worker falling while trying to pick or place the container. These workers often go onto a scissor lift, tall ladder, or use a forklift to access containers on upper shelving. Even with proper training, these can be hazardous activities. Accordingly, certain aspects of the present invention contemplate an automatic system for picking and placing containers from these dangerous locations. As such, some exemplified embodiments of a rack-mounted automated picking system are described herein below.

With that in mind, embodiment disclosed herein imagine an automatic system for picking and placing containers on a rack or shelving structure, or onto a cart. A hub is configured to communicate with one or more robots, an automated cart(s), and the warehouse management software. Software that converts the list of materials requested by the warehouse management software into rack or shelving unit locations for the robots to pick from. A modular robot comprised of an extension platform and at least one drive unit that rides on a series of horizontal and driven vertical supports coupled to the warehouse rack or shelving unit. An extension mechanism and capture mechanism extends and retracts from an extension platform to pick and place containers.

The robot 41 is attached to the vertical supports 1 of a warehouse storage structure 42 via a horizontal rail 2 attached at either end. The horizontal support rail is attached directly to the rack or shelving unit 42. In another embodiment, a bracket 40 specific to the rack or shelving unit 42 mounting features is connected to the horizontal support rail 2 before attaching to the rack or shelving unit 42. A vertical support rail 3 is attached to a horizontal drive unit 4, which is then attached to the horizontal support rail 2. In one embodiment, the horizontal drive unit 4 comprises a motor 5 with a non-backdriveable gear box 6, a gear 7, and a support roller 8. The top surface of the horizontal support rail comprises a rack 9, which interfaces with the gear 7.

A moving extension platform 10 is attached to a vertical drive unit 11, which is then attached to the vertical support rail 3. In one embodiment, the vertical drive unit 11 comprises a motor 12 with a non-backdriveable gear box 13, a gear 14, and a support roller 15. One side surface of the vertical support rail comprises a rack 16, which interfaces with the gear 14. Other embodiments may include additional vertical support rails 17, which may or may not house a rack and/or additional vertical drive units 18. In one embodiment, the vertical support rail(s) 3, 17 are connected to a rolling mechanism 19, such as a wheel, allowing the robot 41 to roll along the floor. In another embodiment, the rolling mechanism is driven by a powered drive unit 21 to roll the robot 41 along the floor. In another embodiment, the vertical support rail(s) 2 and 3 are free-hanging and supported by the horizontal rail 2. In another embodiment, one or more additional horizontal support rails are added to locations along the vertical supports 1 of the storage structure 42.

In this embodiment, the combination of the vertical motion along the vertical support rails 3 and the horizontal motion along the horizontal rail 2 positions the extension platform 10 anywhere on the front surface of the rack or shelving unit 42. Once located, the extending mechanism 32 pushes the capture mechanism 33 toward the box 37. Once the capture mechanism 33 has traversed the box 37 and captured it, the extending mechanism 32 retracts the capture mechanism 33 with the box 37 and deposits the box in the open center of the extension platform 10.

In this embodiment, the extension platform 10 is a “C” shape and houses the drives and mechanisms used for the extending mechanism 32. In another embodiment, the extension platform houses the drives and mechanisms used for the extending mechanism with two parallel rails and no closed end. In another embodiment, the extension platform 10 resides entirely beneath the extending mechanism 32.

The extension platform 10 has an externally facing indicator 21 that indicates status of the device. In addition, the extension platform 10 comprises a controller 22 for controlling drive units, sensors, and communicating with the communication hub 43. The extension platform also houses multiple sensors, including for detecting nearby objects 23, barcode reader 24, container detection 25, impact detection 26, robot vertical position 27, robot horizontal position 28, capture mechanism position 29, and box detection 30. The extension platform 10 has a housing 31, extending mechanism 32, and capture mechanism 33.

The robot is part of a larger rack-mounted automated picking system. The robot communicates with a communication hub 43, which in turn communicates with the warehouse's management software. In another embodiment, the robot also communicates with an automated cart 44, which moves the containers along the floor from the pick location to a predetermined dropoff location within the warehouse. The automated cart 44 also communicates with the hub.

The communication hub 43 is comprised of a housing, a printed circuit board, and software. A User or the Warehouse's management software outputs a list of containers to pick from the Warehouse management software, along with their respective locations on the rack or shelving unit. For the picking operation, the communication hub 43 receives data from the warehouse management software, which it then stores in its onboard memory. This information is then communicated to the robot 42 and/or automated cart 44. In one embodiment, an indicator shows the state of the hub 43. In another embodiment, a touchscreen LCD and Graphic User Interface is used to indicate status and act as the human interface.

The robot 42 receives the data from the communication hub 43 and translates the container shelf position into motion parameters for the horizontal drive unit 4, the vertical drive unit 11, the extending mechanism 32, and the capture mechanism 33. In parallel, the automated cart 44 receives the information and moves into a predetermined dropoff location next to the robot's rack or shelving unit 42. The robot moves from its default state 34 to the vertical and horizontal location of the container. Using sensors on the extension platform's arms, the edges of the container are found and the barcode label verified against the list of materials. The capture mechanism 33 width is adjusted 35 for the container size and the extension mechanism 32 extends 36 to the container. The capture mechanism 32 grabs the container and the extension mechanism retracts with the container back into the extension platform. The robot 41 moves the extension platform 10 just above the automated cart 44 and releases the container for dropoff 39. The robot 42 then moves the extension platform 10 clear of the container 45 and cart 44, then returns to the default state 34.

To initially place containers on the rack or shelving unit 42, a User places container(s) 45 in the robot's pickup area 39. In this embodiment, a container 45 may be placed on the floor, on a pallet, on the automated cart 44, or on a manual pushcart. The robot 41 moves the extension platform 10 over a container 45, finds the edges, and scans the barcode. Based on the container size, the robot controller calculates an efficient position and, in some cases, essentially the optimal position on the rack or shelving unit 42. This location is translated into motion parameters for the drive units and the container is picked from the floor and placed on the rack or shelving unit 42. This process is repeated until either all the containers are placed on the shelves, or all the shelves are full. A signal indicating final system state is sent to the cart 44 and hub 43. The hub 43 then updates the warehouse's management software.

The automated system has a plurality of safety systems to prevent collision and damage to the automated system, the rack or shelving unit, objects around the system, and personnel. Electronics throughout the system's drive units and housing detect proximity of an object, as well as any collision or unplanned stop. Upon detection, the automated system's software stops all motion. In addition, indicators change color and/or make a sound, showing the state of the system.

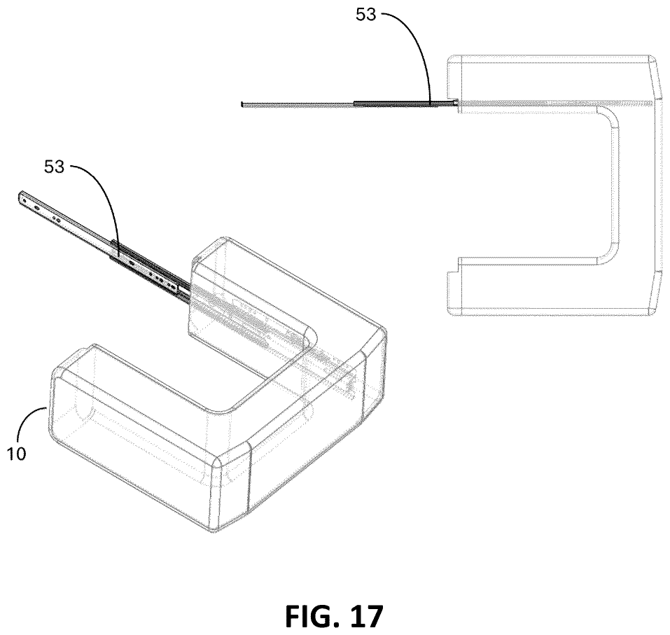

FIG. 17 illustratively depicts a telescoping slide U-shaped picking device embodiment showing the U-shaped frame, which is defined by two sides extending from a base, the U-shaped frame configured to accommodate a shipping box, wherein the U-shaped frame comprises two terminal ends. In this embodiment, the extending mechanism 32 in the extension platform is comprised of a telescoping arm 53. The telescoping arm 53 attaches to a capture mechanism 33. The telescoping arm 53, or pair of retractable arms, slidingly engaged on an inside portion of the two sides, the pair of retractable arms connected to at least one arm extension motor, wherein the at least one arm extension motor is configured to extend and retract the pair of retractable arms from the two terminal ends. Each of the retractable arms comprising a motorized gripping bar that confront one another, wherein the motorized gripping bars are configured to be driven towards or away from one another via gripping bar motors (not shown). The U-shaped frame cooperates with at least one vertical frame via a vertical drive motor configured to move the U-shaped frame vertically along the vertical frame. The vertical frame extending from a horizontal displacing platform configured to carry the vertical frame horizontally from a first horizontal location to a second horizontal location.

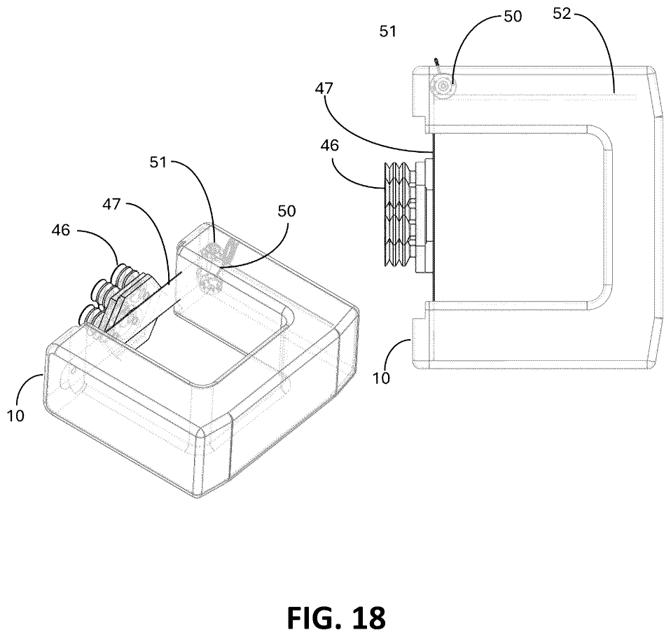

FIG. 18 illustratively depicts the U-shaped picking device with a rack and pinion consistent with embodiments of the present invention. In this embodiment, the extending mechanism 32 in the extension platform is comprised of a DC motor 50 with a spur gear 51 that drives a rack 52. The rack gear 52 drives the capture mount 47 in and out of the rack or shelving unit. Attached to the capture mount 47 is a vacuum gripper 46. When the vacuum gripper 46 makes contact with the box, it will capture the box. When the vacuum gripper 46 recedes from the rack, the box will remain connected to it until it is deposited in the center of the extension platform 10.

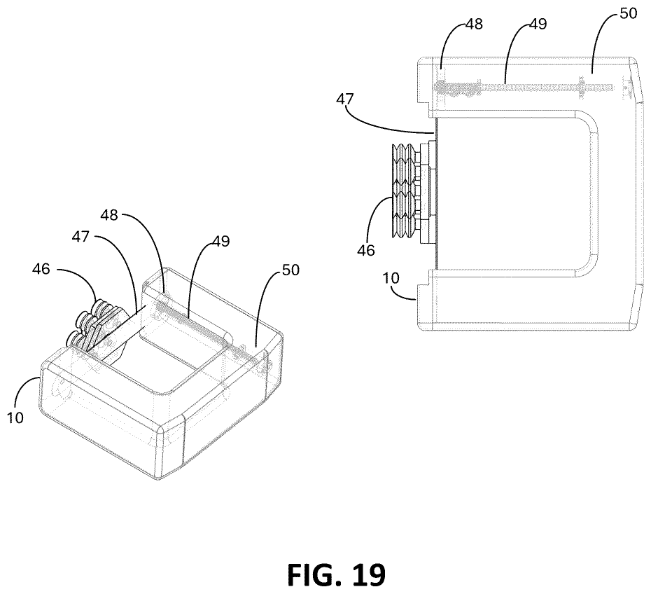

FIG. 19 illustratively depicts a ball screw arrangement consistent with embodiments of the present invention. In this embodiment, the extending mechanism 32 in the extension platform is comprised of a DC motor 50 with a ball screw 49 that drives a flanged ball nut 48. The flanged ball nut 48 drives the capture mount 47 in and out of the rack or shelving unit. Attached to the capture mount 47 is a vacuum gripper 46. When the vacuum gripper 46 makes contact with the box, it will capture the box. When the vacuum gripper 46 recedes from the rack, the box will remain connected to it until it is deposited in the center of the extension platform 10.

It is to be understood that even though numerous characteristics and advantages of various embodiments of the present invention have been set forth in the foregoing description, together with the details of the structure and function of various embodiments of the invention, this disclosure is illustrative only, and changes may be made in detail, especially in matters of structure and arrangement of parts within the principles of the present invention to the full extent indicated by the broad general meaning of the terms used herein. For example, though embodiments of the present invention describe the fundamental elements of a rafter hanger 100, certain elements can be altered, such as dimensions, without departing from the scope and spirit of the present invention. It should also be appreciated that there may be aspects of the mechanical elements not discussed in detail in the present disclosure that must be implemented in accordance known to those skilled in the art. The specification and drawings are to be regarded as illustrative and exemplary rather than restrictive. For example, the word “preferably,” and the phrase “preferably but not necessarily,” are used synonymously herein to consistently include the meaning of “not necessarily” or optionally. “Comprising,” “including,” and “having,” are intended to be open-ended terms and “consisting” is considered a closed term.

It will be clear that the claimed invention is well adapted to attain the ends and advantages mentioned as well as those inherent therein. While presently preferred embodiments have been described for purposes of this disclosure, numerous changes may be made which readily suggest themselves to those skilled in the art and which are encompassed in the spirit of the claimed invention disclosed and as defined in the appended claims. Accordingly, it is to be understood that even though numerous characteristics and advantages of various aspects have been set forth in the foregoing description, together with details of the structure and function, this disclosure is illustrative only, and changes may be made in detail, especially in matters of structure and arrangement to the full extent indicated by the broad general meaning of the terms in which the appended claims are expressed.

What is claimed is:

1. A robotic picker comprising:
a U-shaped frame defined by two sides extending from a base, the U-shaped frame configured to accommodate a shipping box, wherein the U-shaped frame comprises two terminal ends;
a pair of retractable arms slidingly engaged on an inside portion of the two sides, the pair of retractable arms connected to at least one arm extension motor, wherein the at least one arm extension motor is configured to extend and retract the pair of retractable arms from the two terminal ends;
each of the retractable arms comprising a motorized gripping bar that confront one another, wherein the motorized gripping bars are configured to be driven towards or away from one another via gripping bar motors;
the U-shaped frame cooperating with at least one vertical frame via a vertical drive motor configured to move the U-shaped frame vertically along the vertical frame; and
the vertical frame extending from a horizontal displacing platform configured to carry the vertical frame horizontally from a first horizontal location to a second horizontal location.
